(19) United States
(12) Patent Application Publication
(10) Pub. No.: US 2017/0067202 A1
(43) Pub. Date: Mar. 9, 2017

(54) Cleaning Brush Structure for Washing Machine

(71) Applicant: Chih-Min Hsu, Taichung City (TW)

(72) Inventor: Chih-Min Hsu, Taichung City (TW)

(21) Appl. No.: 15/241,132

(22) Filed: Aug. 19, 2016

(30) Foreign Application Priority Data
Sep. 7, 2015 (TW) 104129444

(51) Int. Cl. D06F 39/06; B08B 1/00

(52) U.S. Cl. CPC D06F 39/06; B08B 1/002

(57) ABSTRACT

A cleaning brush structure is applicable for a washing machine, and the washing machine contains: a body in which an external drum is mounted, and the external drum accommodates an internal drum having a plurality of through orifices. Each of the plurality of through orifices accommodates a cleaning brush which includes a fixing element and a brushing element, and the fixing element has a conical face formed on a peripheral wall thereof, a small-diameter segment arranged on a first end thereof, and a large-diameter segment arranged on a second end thereof opposite to the first end of the fixing element. The brushing element is mounted on the small-diameter segment of the fixing element and has bristles inserted through said each through orifice so that the fixing element is fixed in said each through orifice of the internal drum.

### FIELD OF THE INVENTION

The present invention relates to a cleaning brush structure, and more particularly to the cleaning brush structure which is applicable for a washing machine.

### BACKGROUND OF THE INVENTION

Detergent is added into a conventional washing machine after feeding water into the washing machine so as to eliminate dirties and stains in the washing machine. However, such a cleaning manner to the washing machine is troublesome and spends high cost.

Washing machine brush system is disclosed in US Publication No. 20120234053 and contains a plurality of independent brush sets, wherein each independent brush set is configured to be inserted into a single hole formed in a drum of the washing machine. Each brush independent set includes a plurality of bristles contained within a holder. Each holder is secured adjacent the hole formed in the drum of the washing machine such that the plurality of bristles projects out from the drum and toward a surface to be cleaned. However, the washing machine brush system is complicate and is assembled inconveniently.

To overcome above-mentioned problem, a cleaning brush structure for a washing machine is disclosed in TW Publication No. 201504495 and contains a cleaning brush which has a fixing element and a brushing element, wherein the fixing element has a stopping portion arranged on a first end thereof, a locking portion fixed on a second end thereof, and a trough, wherein the brushing element is in connection with the fixing element and has bristles inserting through each of multiple orifices of an inner drum so that the inner drum is secured in the trough of the fixing element, and the locking portion of the fixing element retains with the inner drum.

Nevertheless, the fixing element is complex and its locking portion is pushed through said each orifice laboriously. In addition, the fixing element cannot insert through orifices of different washing machines.

The present invention has arisen to mitigate and/or obviate the afore-described disadvantages.

### SUMMARY OF THE INVENTION

The primary objective of the present invention is to provide a cleaning brush structure for a washing machine which is capable of brushing the inner wall of the external drum and the outer wall of the internal drum cleanly.

Secondary objective of the present invention is to provide a cleaning brush structure for a washing machine which is removed from the washing machine easily.

Further objective of the present invention is to provide a cleaning brush structure for a washing machine which distinguishes a replacement time of the cleaning brush.

Another objective of the present invention is to provide a cleaning brush structure for a washing machine which washes clothing and cleans the washing machine simultaneously.

To obtain the above objectives, a cleaning brush structure provided by the present invention is applicable for a washing machine, and the washing machine contains: a body in which an external drum is mounted, and the external drum accommodates an internal drum having a plurality of through orifices.

Each of the plurality of through orifices accommodates a cleaning brush which includes a fixing element and a brushing element, and the fixing element has a conical face formed on a peripheral wall thereof, a small-diameter segment arranged on a first end thereof, and a large-diameter segment arranged on a second end thereof opposite to the first end of the fixing element.

The brushing element is mounted on the small-diameter segment of the fixing element and has bristles inserted through said each through orifice so that the fixing element is fixed in said each through orifice of the internal drum.

### BRIEF DESCRIPTION OF THE DRAWINGS

FIG. 1 is a perspective view showing a cleaning brush structure being applicable for a washing machine according to a preferred embodiment of the present invention.

FIG. 2 is a cross sectional view showing the cleaning brush structure being applicable for the washing machine according to the preferred embodiment of the present invention.

FIG. 3 is another cross sectional view showing the cleaning brush structure being applicable for the washing machine according to the preferred embodiment of the present invention.

FIG. 4 is an amplified cross sectional view of a part of FIG. 3.

FIG. 5 is a cross sectional view showing the operation of the cleaning brush structure according to the preferred embodiment of the present invention.

FIG. 6 is another cross sectional view showing the operation of the cleaning brush structure according to the preferred embodiment of the present invention.

FIG. 7 is a perspective view showing the assembly of a cleaning brush structure according to another preferred embodiment of the present invention.

FIG. 8 is a perspective view showing the assembly of a cleaning brush structure according to another preferred embodiment of the present invention.

FIG. 9 is a perspective view showing the assembly of a cleaning brush structure according to another preferred embodiment of the present invention.

FIG. 10 is a perspective view showing the assembly of a cleaning brush structure according to another preferred embodiment of the present invention.

### DETAILED DESCRIPTION OF THE PREFERRED EMBODIMENTS

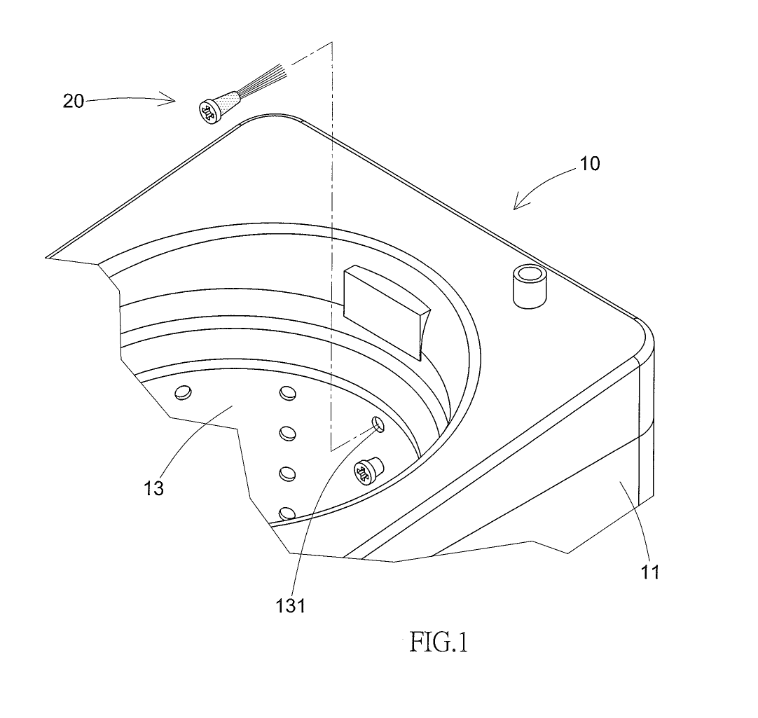

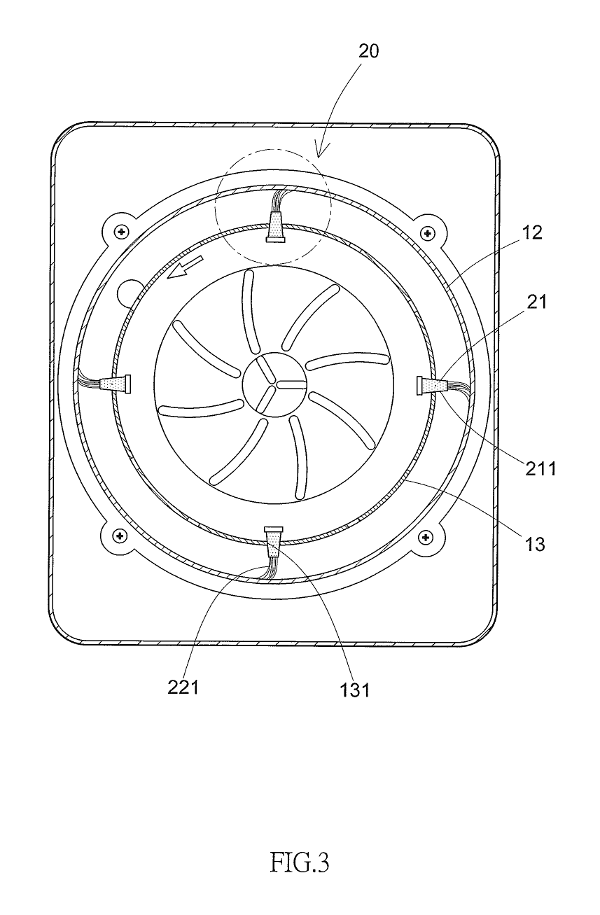

With reference to FIGS. 1-10, a cleaning brush structure according to a preferred embodiment of the present invention is applicable for a washing machine 10, and the washing machine 10 comprises: a body 11 in which an external drum 12 is mounted, and the external drum 12 accommodates an internal drum 13 having a plurality of through orifices 131 (as shown in FIG. 1), wherein the internal drum 13 is driven by a transmission mechanism (not shown) of the washing machine 10 to rotate and to wash clothing.

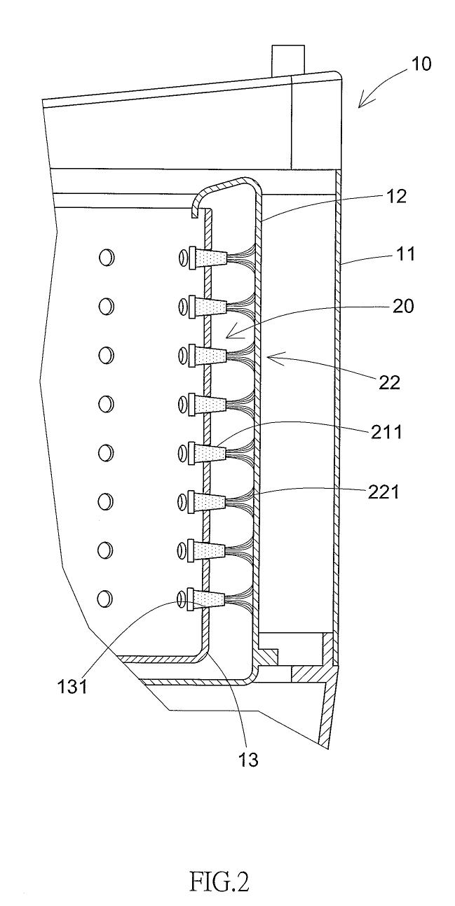

Each of the plurality of through orifices 131 accommodates a cleaning brush 20 which includes a fixing element 21 and a brushing element 22, wherein the fixing element 21 has a conical face 211 formed on a peripheral wall thereof, a small-diameter segment 21A arranged on a first end thereof, and a large-diameter segment 21B arranged on a second end thereof opposite to the first end of the fixing element 21. The brushing element 22 is mounted on the small-diameter segment 21A of the fixing element 21 and has bristles 221 inserted through said each through orifice 131 so that the fixing element 21 is fixed in said each through orifice 131 (as illustrated in FIGS. 2 to 4).

The conical face 211 has a retaining means configured on an outer wall thereof.

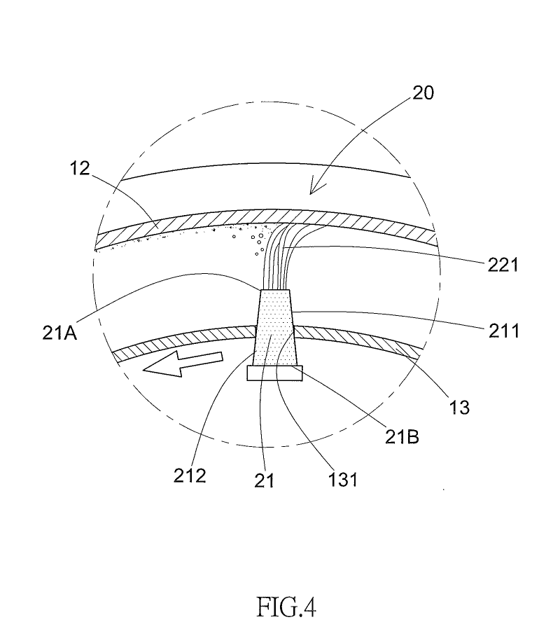

The retaining means is a rough surface 212, as shown in FIG. 4.

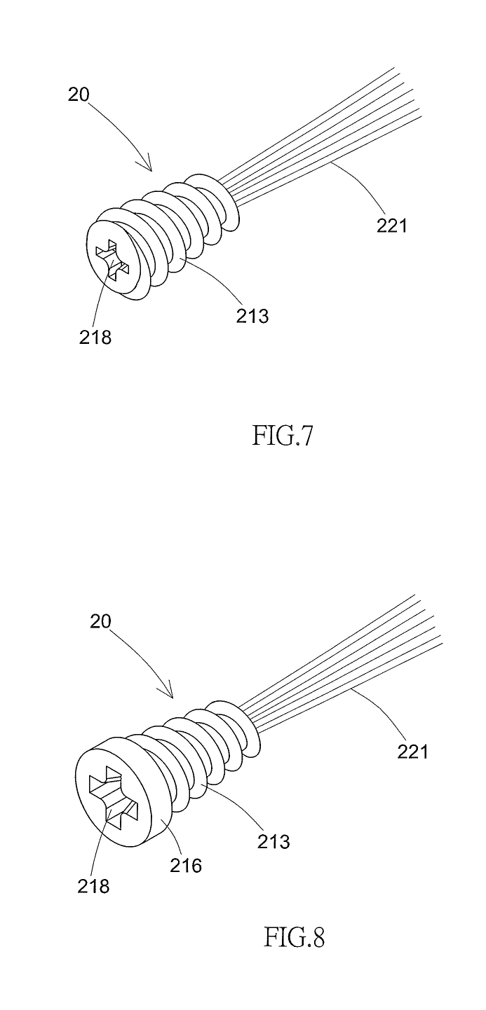

The retaining means is external threads 213, as illustrated in FIG. 7.

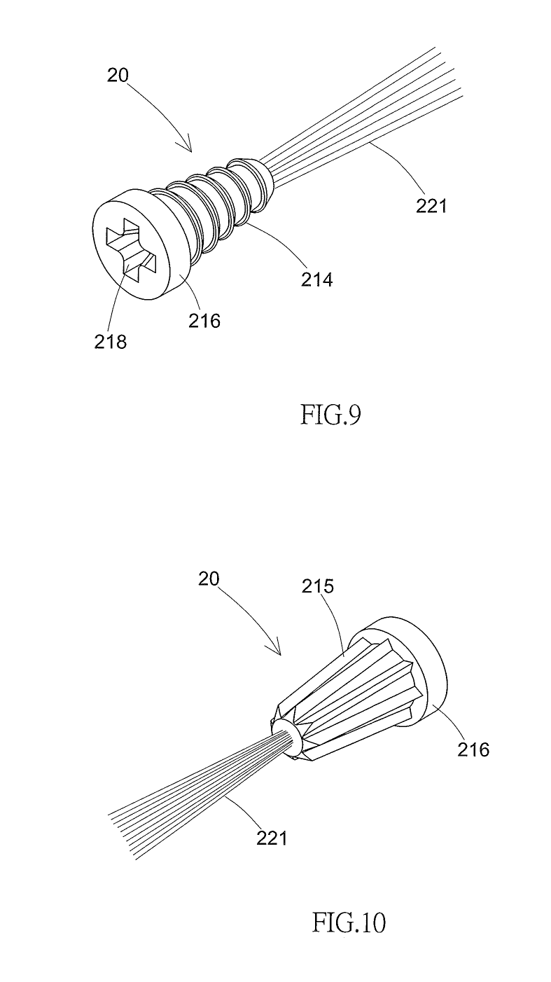

The retaining means is multiple annular rings 214, as shown in FIG. 9.

The retaining means is multiple elongated ribs 215, as illustrated in FIG. 10. Preferably, a cross section of each of the multiple elongated ribs 215 is triangular.

The conical face 211 of the fixing element 21 has an operating means adjacent to the large-diameter segment 21B.

Alternatively, the conical face 211 of the fixing element 21 has a head portion 216 adjacent to the large-diameter segment 21B, and in a connection area of the head portion 216 and the large-diameter segment 21B is defined an abutting face 217, as shown in FIG. 9, wherein the head portion 216 has an operating means opposite to the abutting face 217.

The operating means of the head portion 216 is a cross notch 218 or a straight notch (not shown).

The large-diameter segment 21B of the fixing element 21 has a warning surface on which an abrasion face is arranged, and wherein a color of the warning surface is different from that of the abrasion face (not shown).

Alternatively, the head portion 216 of the fixing element 21 has a warning surface opposite to the abutting face 217, and the warning surface has an abrasion face arranged thereon, wherein a color of the warning surface is different from that of the abrasion face (not shown).

The bristles 221 of the brushing element 22 has aqueous detergent (not shown) adhered thereon.

Referring further to FIGS. 1 to 10, the washing machine 10 is a well-known prior art and is capable of setting washing modes by using at least one button (not shown), and after starting the washing machine 10, the transmission mechanism (not shown) of the washing machine 10 drives the internal drum 13 to rotate leftward and rightward, thus washing the clothing.

Preferably, said each through orifice 131 accommodates the cleaning brush 20 which includes the fixing element 21 and the brushing element 22, hence the fixing element 21 is fixed in said each through orifice 131 so as to brush an inner wall of the external drum 12, and the fixing element 21 is fixed in said each through orifice 131 by using the conical face 211 easily and quickly.

When the internal drum 13 rotates in the body 11, the cleaning brush 20 brushes the inner wall of the external drum 12, as illustrated in FIGS. 2 to 4, thus cleaning the external drum 12 completely. Preferably, the bristles 221 of the brushing element 22 brush an outer wall of the internal drum 13 as well.

With reference to FIG. 5, the bristles 221 of the brushing element 22 has the aqueous detergent (not shown) adhered thereon and are inserted into said each through orifice 131 easily, hence the fixing element 21 is manually fixed in said each through orifice 131 easily. Alternatively, a screwdriver 30 is biased against the cross trough 218 of the fixing element 21 and is rotated so that the fixing element 21 is fixed in said each through orifice 131, as illustrated in FIG. 5. Furthermore, the bristles 221 brush the inner wall of the external drum 12 and the outer wall of the internal drum 13 cleanly.

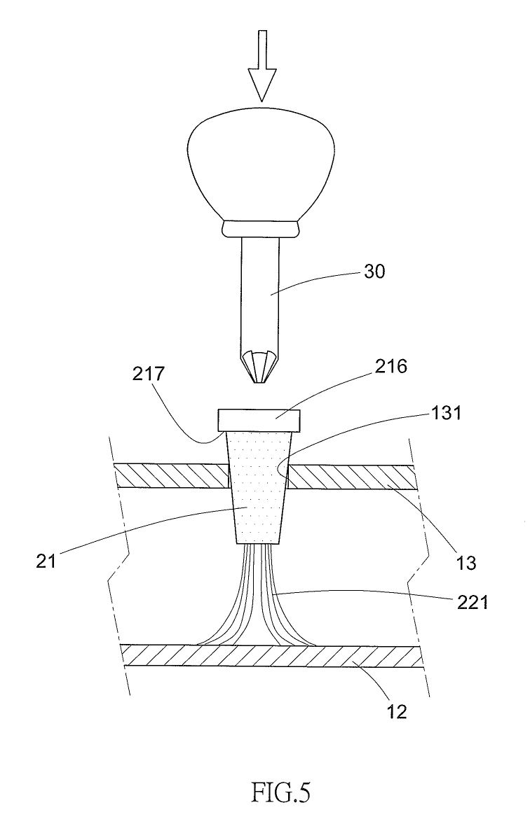

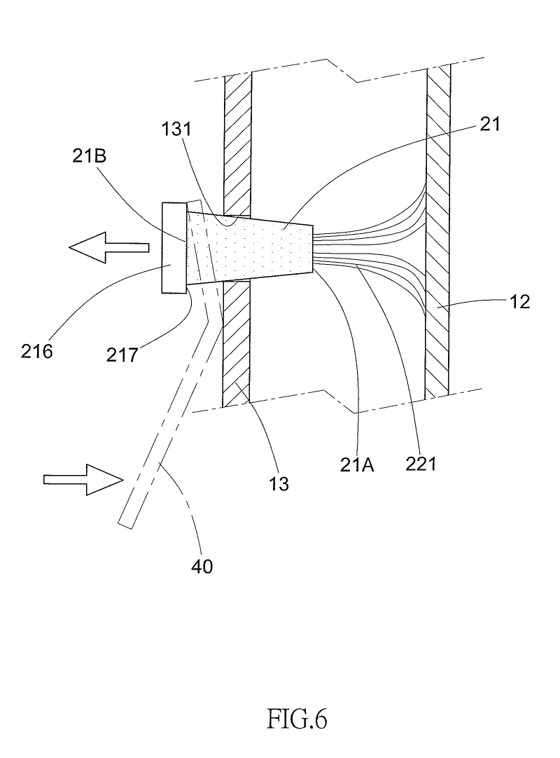

Referring to FIG. 6, the fixing element 21 is clamped by a clamper (not shown) and is pulled out of said each through orifice 131 easily. Alternatively, a removal tool 40 is fitted with the fixing element 21 and pulls the fixing element 21 out of said each through orifice 131, thus removing the cleaning brush 20 quickly.

Due to the large-diameter segment 21B of the fixing element 21 has the warning surface on which the abrasion face is arranged, and the color of the warning surface is different from that of the abrasion face. Alternatively, the head portion 216 of the fixing element 21 has the warning surface opposite to the abutting face 217, the warning surface of the head portion 216 has the abrasion face arranged thereon, and the color of the warning surface of the head portion 216 is different from that of the abrasion face (not shown), hence the warning surface exposes outside after wearing the abrasion face so that user distinguishes a replacement time of the cleaning brush 20. In this embodiment, the color of the warning surface is red or yellow.

The fixing element 21 is fixed in said each through orifice 131 of the internal drum 13 securely by means of the conical face 211 of the fixing element 21, when the internal drum 13 of the washing machine 10 rotates. Preferably, the retaining means of the conical face 211 is any one of the rough surface 212, the external threads 213, the multiple annular rings 214, and the multiple elongated ribs 215, so the fixing element 21 is fixed in said each through orifice 131 of the internal drum 13 securely.

Preferably, the bristles 221 brush the inner wall of the external drum 12 and the outer wall of the internal drum 13 cleanly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A cleaning brush structure being applicable for a washing machine, and the washing machine comprising: a body in which an external drum is mounted, and the external drum accommodating an internal drum having a plurality of through orifices;
wherein each of the plurality of through orifices accommodates a cleaning brush which includes a fixing element and a brushing element, and the fixing element has a conical face formed on a peripheral wall thereof, a small-diameter segment arranged on a first end thereof, and a large-diameter segment arranged on a second end thereof opposite to the first end of the fixing element, wherein the brushing element is mounted on the small-diameter segment of the fixing element and has bristles inserted through said each through orifice so that the fixing element is fixed in said each through orifice of the internal drum.

2. The cleaning brush structure as claimed in claim 1, wherein the conical face has a retaining means configured on an outer wall thereof.

3. The cleaning brush structure as claimed in claim 2, wherein the retaining means is a rough surface.

4. The cleaning brush structure as claimed in claim 2, wherein the retaining means is external threads.

5. The cleaning brush structure as claimed in claim 2, wherein the retaining means is multiple annular rings.

6. The cleaning brush structure as claimed in claim 2, wherein the retaining means is multiple elongated ribs.

7. The cleaning brush structure as claimed in claim 6, wherein a cross section of each of the multiple elongated ribs is triangular.

8. The cleaning brush structure as claimed in claim 1, wherein the conical face of the fixing element has an operating means adjacent to the large-diameter segment.

9. The cleaning brush structure as claimed in claim 1, wherein the fixing element has a head portion adjacent to the large-diameter segment, in a connection area of the head portion and the large-diameter segment is defined an abutting face, and the head portion has an operating means opposite to the abutting face.

10. The cleaning brush structure as claimed in claim 8, wherein the operating means of the head portion is a cross notch.

11. The cleaning brush structure as claimed in claim 9, wherein the operating means of the head portion is a straight notch.

12. The cleaning brush structure as claimed in claim 1, wherein the large-diameter segment of the fixing element has a warning surface on which an abrasion face is arranged, and a color of the warning surface is different from that of the abrasion face.

13. The cleaning brush structure as claimed in claim 9, wherein the head portion of the fixing element has a warning surface opposite to the abutting face, the warning surface has an abrasion face arranged thereon, and a color of the warning surface is different from that of the abrasion face.

14. The cleaning brush structure as claimed in claim 1, wherein the bristles of the brushing element has aqueous detergent adhered thereon.
